(19) United States
(12) Patent Application Publication
(10) Pub. No.: US 2005/0112033 A1
(43) Pub. Date: May 26, 2005

(54) Multi-well containers, systems, and methods of using the same

(75) Inventors: Kanyin E. Zhang, San Diego, CA (US); Douglas Evans, San Diego, CA (US)

Correspondence Address: QUINE INTELLECTUAL PROPERTY LAW GROUP, P.C., P O BOX 458, ALAMEDA, CA, 94501, US

(73) Assignee: IRM, LLC, Hamilton (BM)

(21) Appl. No.: 10/934,646

(22) Filed: Sep. 3, 2004

Related U.S. Application Data
(60) Provisional application No. 60/501,554, filed on Sep. 8, 2003.

(51) Int. Cl. B01L 3/00

(52) U.S. Cl. 422/102

(57) ABSTRACT

The invention provides multi-well containers that include membranes for performing various processes, including analytical and synthetic processes. Related systems, kits, and methods are also provided.

### CROSS-REFERENCES TO RELATED APPLICATIONS

This application claims the benefit of U.S. Provisional Application No. 60/501,554, filed Sep. 8, 2003, the disclosure of which is incorporated by reference in its entirety for all purposes.

### COPYRIGHT NOTIFICATION

Pursuant to 37 C.F.R. §1.71(e), Applicants note that a portion of this disclosure contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### FIELD OF THE INVENTION

The present invention relates generally to multi-well containers, and to related systems and analytic and/or synthetic methods utilizing the multi-well containers.

### BACKGROUND OF THE INVENTION

Equilibrium dialysis is a commonly utilized technique in biomedical research and many drug discovery protocols. For example, equilibrium dialysis is used in studying various molecular interactions, such as protein-ligand binding, and in culturing cells and tissue, among many other biological and chemical applications. In a typical equilibrium dialysis-based binding assay, for example, a semi-permeable or microporous membrane is presented such that at least one molecule passes freely through the membrane, whereas the movement of another molecule is restricted to one side of the membrane due to the size of the molecule. In certain formats, the molecule having restricted movement is free in solution, whereas in others the molecule is presented on the surface of a cell or otherwise immobilized to one side of the membrane. Once equilibrium is achieved, a qualitative and, in some cases, quantitative measure of the extent of binding between the two molecules can be obtained by, for example, determining the concentration of the unbound molecule, which freely passes through the membrane. In cell culture applications, a layer of cells can be attached and grown on the membrane in a nutrient rich medium. The cell layer is able to receive nutrients through the semi-permeable membrane such that a nutrient concentration gradient develops to support cellular growth and development through the membrane. This basolateral approach to cell feeding closely approximates, for example, in vivo conditions in which polarized structures such as epithelial cells functionally behave. To further illustrate other more specific applications of equilibrium dialysis, various synthetic processes can be performed using such an approach. For example, one reactant can be immobilized on a microbead or other solid support, such that the movement of the reactant is restrained to one side of the membrane, while other reactants can be supplied to the reaction through the membrane.

One strategy to improve the throughput of equilibrium dialysis-based procedures has been to perform multiple procedures in parallel utilizing various types of multi-well containers. However, many of these pre-existing devices have a number of shortcomings. To illustrate, some containers include membranes that are vertically or horizontally disposed within the wells of the containers, that is, disposed perpendicular or parallel to top surfaces of these containers. When fluid dispensing devices, such as pipettors access these containers, e.g., to deliver fluid to or aspirate fluid from the wells of the containers, the membranes disposed within these wells are prone to being perforated or otherwise compromised by contact with the fluid dispensing device. One consequence of a compromised membrane may be biased assay results. In addition, devices having horizontally disposed membranes can also yield biased results due to the influence of gravity, which tends to balance the equilibrium towards one side of the membrane, that is, the side of well that lies below the membrane, relative to devices having membranes that are vertically disposed in wells.

From the foregoing discussion, it is apparent that multi-well containers for performing equilibrium dialysis-based processes that do not suffer from the limitations of many of these pre-existing devices are desirable. These and a variety of other features of the present invention will be apparent upon a complete review of the following disclosure.

### SUMMARY OF THE INVENTION

The present invention relates generally to devices for performing many different types of assays, including dialysis-based binding assays, and various synthesis reactions. More specifically, the devices of the invention are provided in a multi-well container format such that multiple assays and/or syntheses can be performed substantially simultaneously with one another with higher throughput than many pre-existing devices. The multi-well containers described herein are also included in systems that further include fluid handling components and/or other system components that facilitate, e.g., the performance of highly automated procedures using the multi-well containers of the invention. The invention also provides kits and related methods that include or use these multi-well containers. In addition, the invention also relates to methods of fabricating the devices described herein.

In one aspect, the invention provides a multi-well container that includes at least two wells disposed in a surface of the multi-well container and at least one chamber disposed in the multi-well container. The chamber communicates with the wells. Optionally, the chamber communicates with more than two wells. In certain embodiments, the chamber comprises at least one channel or another type of cavity. The multi-well container also includes at least one membrane (e.g., a semi-permeable membrane or the like) disposed in the chamber between the wells. At least a portion of the membrane is disposed substantially normal to a bottom surface of the chamber. In some embodiments, the multi-well container, or components thereof, are disposable, whereas in others they are reusable. Typically, at least a portion of the wells, the chamber, or both the wells and the chamber comprise a non-adsorbing surface and/or a non-reactive surface, such as a TEFLON ® or another hydrophobic coating. Optionally, a multi-well container described herein further includes at least one sealing component that is structured to seal (e.g., reversibly seal) one or more of the wells disposed in the surface of the multi-well container.

In some embodiments of the invention, multiple lines of wells are disposed in the surface of the multi-well container and multiple chambers are disposed in the multi-well container in which one or more chambers communicate with at least one pair of wells disposed in identical lines of wells, different lines of wells, or both identical and different lines of wells. In certain embodiments, at least one of the chambers communicates with wells that are different from other wells with which other chambers communicate. Typically, each chamber communicates with a different pair of wells disposed in consecutive pairs of lines of wells. To further illustrate, the well container optionally comprises n pairs of consecutive lines of wells and at least n multi-membranes in which one or more membranes are disposed between each pair of consecutive lines of wells, where n is an integer greater than 0. The multi-well container typically comprises, e.g., 6, 12, 24, 48, 96, 192, 384, 768, 1536, or more wells.

In certain embodiments, the wells of the multi-well container are disposed in different segments of the multi-well container. In these embodiments, the segments and membrane are separable from one another at least prior to assembly of the multi-well container. For example, the segments optionally comprise separable blocks or the like. To further illustrate, the multi-well container typically comprises n segments and at least n/2 membranes in which one or more membranes are disposed between at least one pair of adjacent segments, where n is an integer greater than 1. The multi-well container typically comprises, e.g., 2, 3, 4, 5, 6, 7, 8, 9, 10, 11, 12, 13, 14, 15, 16, 17, 18, 19, 20, or more separable segments. The segments are generally separable from one another along planes that are substantially vertically disposed through the multi-well container. The membrane is typically disposed between the segments when the multi-well container is assembled. Typically, each segment comprises a portion of the chamber. In some embodiments, each segment comprises at least one line of wells and at least portions of multiple chambers. In these embodiments, at least one of the portions of the chambers typically communicates with one or more wells disposed in the line of wells that are different from other wells disposed in the line of wells with which other portions of the chambers communicate. For example, the portions of the chambers disposed in at least a first segment optionally correspond to the portions of the chambers disposed in at least a second segment such that the corresponding portions of the chambers in the first and second segments communicate with one another when the multi-well container is assembled. The segments and the membrane are generally attached to one another using at least one attachment technique when the multi-well container is assembled. To illustrate, the attachment technique is optionally selected from, e.g., bonding the segments together, adhering the segments together, bolting the segments together, screwing the segments together, clamping the segments together, and the like. In certain embodiments of the invention, the multi-well container further includes at least one electrode disposed in electrical communication with each of the wells, a portion of the chamber, or each of the wells and a portion of the chamber, e.g., to effect electrodialysis, resistive heating, etc. in the container.

The multi-well containers of the invention are optionally included as components of systems, e.g., for performing various assays or syntheses in the wells of the containers. To illustrate, the multi-well container optionally further includes at least one fluid handling component (e.g., a liquid handling robotic system, an HPLC autosampler, etc.) comprising at least one fluid handler that is structured to at least dispense one or more fluidic materials into one or more wells of the multi-well container. Typically, the fluid handling component comprises multiple fluid handlers in which at least two of the fluid handlers are spaced at a distance that substantially corresponds to a distance between two or more wells disposed in the multi-well container. In some of these embodiments, the fluid handling component is hand-held, whereas in others, the fluid handling component comprises at least one translocation device that translocates the fluid handler and the multi-well container relative to one another. In certain embodiments, the multi-well container further includes at least one positioning component that is structured to position the multi-well container relative to the fluid handling component. Optionally, the multi-well container further includes at least one thermal regulator operably connected to the multi-well container, which thermal regulator regulates temperature in the wells and chamber. In some embodiments, the thermal regulator is integral with the multi-well container. In certain embodiments, the multi-well container further includes at least two electrodes disposed in electrical communication with at least one of the wells, a portion of the chamber, or at least one of the wells and a portion of the chamber. In these embodiments, the multi-well container generally further includes at least one electrical power source operably connected to the electrodes to apply a voltage between the electrodes when conductive material is disposed in the wells and chamber of the multi-well container.

In another aspect, the invention relates to a multi-well container that includes multiple lines of wells disposed in a surface of the multi-well container. At least two of the lines of wells are disposed in different segments of the multi-well container in which the multi-well container comprises at least three segments, which segments are separable from one another at least prior to assembly of the multi-well container. The multi-well container also includes multiple chambers disposed in the multi-well container in which portions of at least one chamber are disposed in at least two of the segments. The chamber communicates with at least one well disposed in each of the two segments of the multi-well container. In addition, the multi-well container also includes at least one membrane disposed between the portions of the chamber such that the membrane is disposed in the chamber between the wells when the multi-well container is assembled.

In still anther aspect, the invention provides a multi-well container that includes multiple pairs of wells disposed in a surface of the multi-well container and multiple chambers disposed in the multi-well container in which at least two of the chambers communicate with different pairs of wells. In addition, the multi-well container also includes multiple membranes disposed in the multi-well container in which at least two of the membranes are disposed in the chambers that communicate with the different pairs of wells.

In another aspect, the invention provides a kit that includes a multi-well container that includes at least two wells disposed in a surface of the multi-well container and at least one chamber disposed in the multi-well container, which chamber communicates with the wells. The multi-well container also includes at least one membrane disposed in the chamber between the wells in which at least a portion of the membrane is disposed substantially normal to a bottom surface of the chamber. The kit also includes instructions for performing one or more assays and/or syntheses in the wells of the multi-well container. In some embodiments, the wells are disposed in different segments of the multi-well container, which segments and membrane are separable from one another. In these embodiments, the segments and the membrane are generally attached to one another using at least one attachment technique. Optionally, the kit further comprises instructions for assembling and dissembling the segments and the membrane.

In another aspect, the invention provides a kit that includes a multi-well container comprising multiple lines of wells disposed in a surface of the multi-well container in which at least two of the lines of wells are disposed in different segments of the multi-well container. The multi-well container comprises at least three segments, which segments are separable from. one another at least prior to assembly of the multi-well container. The multi-well container also includes multiple chambers disposed in the multi-well container in which portions of at least one chamber are disposed in at least two of the segments, which chamber communicates with at least one well disposed in each of the two segments of the multi-well container. In addition, the multi-well container also includes at least one membrane disposed between the portions of the chamber such that the membrane is disposed in the chamber between the wells when the multi-well container is assembled. The kit also includes instructions for performing one or more assays or syntheses in the wells of the multi-well container.

In another aspect, the invention provides a method of performing a binding assay. The method includes providing a multi-well container comprising at least two wells disposed in a surface of the multi-well container and at least one chamber disposed in the multi-well container, which chamber communicates with the wells. At least one semi-permeable membrane (e.g., a dialysis membrane, etc.) is disposed in the chamber between the wells, and at least a portion of the membrane is disposed substantially normal to a bottom surface of the chamber. The method also includes dispensing at least a first fluid into a first of the two wells, which first fluid (e.g., serum, plasma, etc.) comprises at least a first component. Optionally, the first component is immobilized on a cellular membrane or on a surface of the first of the two wells. In certain embodiments, a cell population comprises the first component, which cell population is dispensed into the first of the two wells in the first fluid. In some of these embodiments, the cell population is grown in the first of the two wells prior to dispensing the second fluid into the first or the second of the two wells. Further, the method also includes dispensing at least a second fluid into the first or the second of the two wells, which second fluid comprises at least a second component. To illustrate, the first and second components are optionally independently selected from, e.g., organic molecules, inorganic molecules, ligands, drugs, polynucleotides, polypeptides, peptides, enzymes, receptors, antibodies, antigens, neurotransmitters, cytokines, chemokines, hormones, lipids, carbohydrates, and the like. Typically, at least some unbound second component flows through the semi-permeable membrane from one well to another well. In addition, the method also includes determining whether the first component binds to the second component, thereby performing the binding assay. Concentrations of unbound second component in the first and second wells are typically allowed to equilibrate prior to performing the determining step. In some embodiments, the method further includes dispensing at least a third fluid (e.g., a buffer, etc.) into the first or the second of the two wells. In certain embodiments, the method further includes dispensing at least one modulator into the first or second well before or after dispensing the second fluid into the first or second of the two wells, which modulator modulates binding of the first and second components to one another. Optionally, the method further includes heating, centrifuging, and/or shaking the fluids in the wells, e.g., using a thermal regulator, a centrifuge, and/or a shaking device. In some embodiments, the method further includes sealing (e.g., with a sealing component) one or more of the wells disposed in the surface of the multi-well container, e.g., to minimize the risk of well contents becoming contaminated during device storage, when a particular assay step is performed, and the like.

In certain embodiments, the determining step includes detecting at least one detectable signal that indicates a concentration of unbound first component or unbound second component. In some embodiments, the detectable signal that indicates the concentration of the unbound first component or the unbound second component is detected multiple times when performing the binding assay. Optionally, the detectable signal is detected in the first well, in the second well, or in both the first and second wells. To illustrate, the detectable signal is typically selected from, e.g., an electromagnetic emission, an electromagnetic absorbance, a fluorescence, a phosphorescence, a chemiluminescence, a refractive index, a cellular activity, a color shift, a fluorescence resonance energy transfer, a pH, a mass, a temperature, and the like. In some embodiments, the method further includes comparing the detected concentration of the unbound first component or the unbound second component with a control concentration of the unbound first component or the unbound second component to provide a measure of first and second components binding to one another. In some embodiments, the determining step comprises removing at least one aliquot of fluid from the first well, the second well, or both the first and second wells, and detecting the detectable signal in the aliquot. For example, the aliquot is typically removed from the first well, the second well, or both the first and second wells using at least one fluid handling component.

In some embodiments, the wells and at least portions of the chamber are disposed in different segments of the multi-well container, which segments and the semi-permeable membrane are separable from one another. In these embodiments, the providing step generally includes placing the semi-permeable membrane over at least one of the portions of the chamber in at least one of the segments and attaching the segments to one another using at least one attachment technique such that the semi-permeable membrane is disposed in the chamber between the wells. Optionally, the method further includes detaching the segments and the semi-permeable membrane from one another after the determining step and washing at least the segments.

In another aspect, the invention provides a method of fabricating a multi-well container. The method includes providing a multi-well container fabrication element comprising at least two wells disposed through a surface of the multi-well container fabrication element and at least one chamber disposed in the multi-well container fabrication element, which chamber communicates with the wells. The method also includes separating the multi-well container fabrication element into at least two segments using at least one separation technique in which each segment comprises at least one well and at least a portion of the chamber. In addition, the method also includes disposing at least one membrane over the portion of the chamber disposed in at least one of the segments, and attaching the segments together using at least one attachment technique such that the membrane is disposed in the chamber between the wells, thereby fabricating the multi-well container.

### BRIEF DESCRIPTION OF THE DRAWINGS

FIG. 1 schematically shows a multi-well container from a top view according to one embodiment of the invention.

FIG. 2 schematically illustrates the multi-well container of FIG. 1 and a sealing component from perspective views.

FIG. 3 schematically depicts an exploded perspective view of the multi-well container of FIG. 1.

FIG. 4A schematically shows a segment from the multi-well container of FIG. 1 from a side elevational view.

FIG. 4B schematically illustrates the segment of FIG. 4A from a perspective view.

FIG. 4C schematically illustrates the segment of FIG. 4A from a top view.

FIG. 4D schematically shows the segment of FIG. 4A from a bottom view.

FIG. 4E schematically depicts the segment of FIG. 4A from a transparent side elevational view.

FIG. 4F schematically shows a detailed view of a portion of a chamber from the segment of FIG. 4A.

FIG. 4G schematically illustrates a cross-sectional view through the portion of the chamber of FIG. 4F.

FIG. 5 schematically shows a portion of a multi-well container segment having electrodes disposed in electrical communication with wells and chamber portions of the segment from a side elevational view according to one embodiment of the invention.

FIG. 6A schematically depicts the multi-well container clamping mechanism from the multi-well container of FIG. 1 from a top view.

FIG. 6B schematically shows the multi-well container clamping mechanism of FIG. 6A from a perspective view.

FIG. 7A schematically illustrates a multi-well container support structure having a partially assembled multi-well container disposed thereon from a side view according to one embodiment of the invention.

FIG. 7B schematically shows the multi-well container support structure of FIG. 7A having an assembled multi-well container from a perspective view.

FIG. 7C schematically depicts the multi-well container support structure of FIG. 7A from a top view.

FIG. 7D schematically shows a cross-sectional view of the multi-well container support structure of FIG. 7A.

FIG. 8A schematically shows a multi-well container fabrication element from a top view prior to being separated into segments according to one fabrication method of the invention.

FIG. 8B schematically illustrates a segment after being separated from the multi-well container fabrication element of FIG. 8A from a side elevational view.

FIG. 9 schematically illustrates a system including a fluid handling component and a positioning component from a perspective view according to one embodiment of the invention.

FIG. 10 schematically shows another positioning component from a perspective view according to one embodiment of the invention.

FIG. 11 schematically depicts the system of FIG. 9 operably connected to a representative logic device according to one embodiment of the invention.

### DETAILED DISCUSSION OF THE INVENTION

I. Definitions

Before describing the present invention in detail, it is to be understood that this invention is not limited to particular multi-well containers, systems, kits, or methods, which can, of course, vary. It is also to be understood that the terminology used herein is for the purpose of describing particular embodiments only, and is not intended to be limiting. Further, unless defined otherwise, all technical and scientific terms used herein have the same meaning as commonly understood by one of ordinary skill in the art to which this invention pertains. In describing and claiming the present invention, the following terminology and grammatical variants will be used in accordance with the definitions set forth below.

The phrase “substantially normal” with reference to the relative orientation of two objects, or portions thereof, to one another means that the objects, or the portions thereof, are approximately perpendicular to one another. For example, two objects, or portions of the objects, are substantially normal to one another when surfaces of the objects form an angle that is typically between about 75° and 105°, and more typically between about 85° and 95° (e.g., about 86°, 87°, 88°, 89°, 90°, 91°, 93°, or 94°). To further illustrate, in some embodiments, a portion of a membrane is disposed substantially normal to a bottom surface of a chamber disposed in a multi-well container of the invention.

A chamber “communicates” with a well of a multi-well container when material (e.g., gaseous-, liquid-, and/or solid-phase material) can be translocated, e.g., to and/or from at least a portion of the chamber through the well.

Objects and/or regions are in “electrical communication” with one another when electrical current is capable of being conducted between the objects and/or regions. In some embodiments, for example, electrodes are disposed in multi-well containers such that current can be conducted in wells and/or chambers between the electrodes.

A “line of wells” disposed in a multi-well container, or a segment thereof, refers to at least a subset of wells disposed in the container, which subset includes at least one linear array of two or more wells. In certain embodiments, for example, a line of wells includes at least one column or row of wells disposed in a multi-well container, or a subset of wells in such a row or column.

The term “top” refers to the highest point, level, surface, or part of a device, or device component, when oriented for typical designed or intended operational use, such as removing material from a well of a multi-well container. In contrast, the term “bottom” refers to the lowest point, level, surface, or part of an device, or device component, when oriented for typical designed or intended operational use.

A “multi-well container fabrication element” refers to a multi-well container body structure prior to being separated into segments according to certain fabrication methods of the invention.

Multi-well container components, such as segments, membranes, clamping mechanisms, and the like are “attached” to one another, either removably or permanently, when they are oriented relative to one another in an assembled or partially assembled multi-well container.

II. Multi-well Containers

The invention provides multi-well containers that can be used or adapted for use in performing various analytic and/or synthetic protocols. The containers described herein are optionally utilized in highly automated systems with minimal user intervention for repeated usage at high throughput in, e.g., laboratory and industrial settings. The multi-well containers of the invention are configured such that fluid handling components, including multi-channel pipetting devices, can readily access the wells of the containers without contacting membranes disposed in the wells unlike certain pre-existing devices. This type of contact frequently results in piercing or other damage to the membrane, which may bias assay results. Moreover, the membranes of the devices of the invention are typically substantially vertically oriented to eliminate potential bias introduced in certain dialysis-based procedures due to gravity.

While the present invention will be described with reference to a few specific embodiments, the description is illustrative of the invention and is not to be construed as limiting the invention. Various modifications to the present invention can be made to the embodiments described herein by those skilled in the art without departing from the true scope of the invention as defined by the appended claims. It is noted here that for a better understanding, like components are designated by like reference letters and/or numerals throughout the various figures, unless the context indicates otherwise.

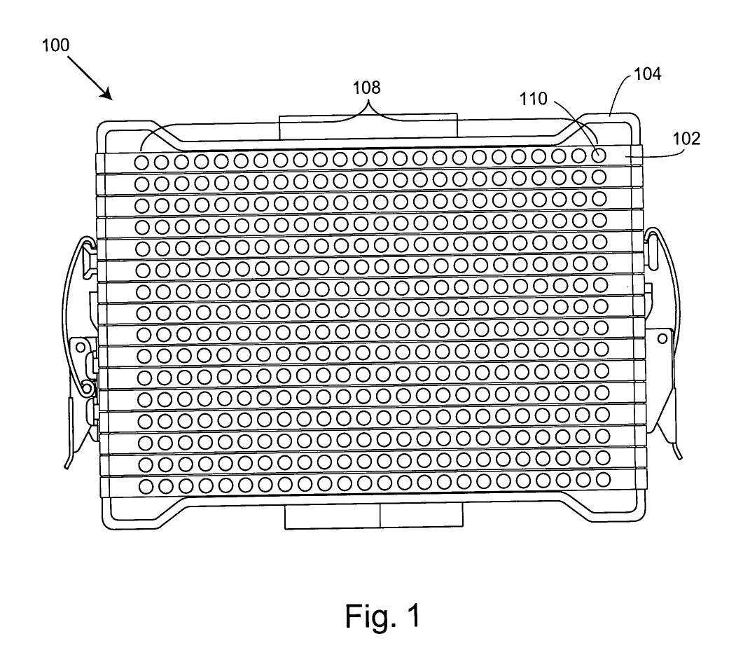

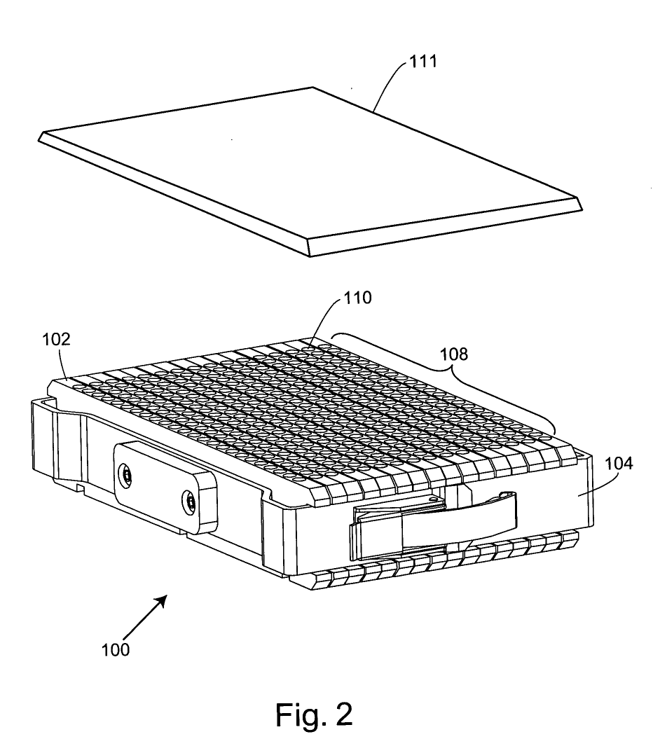

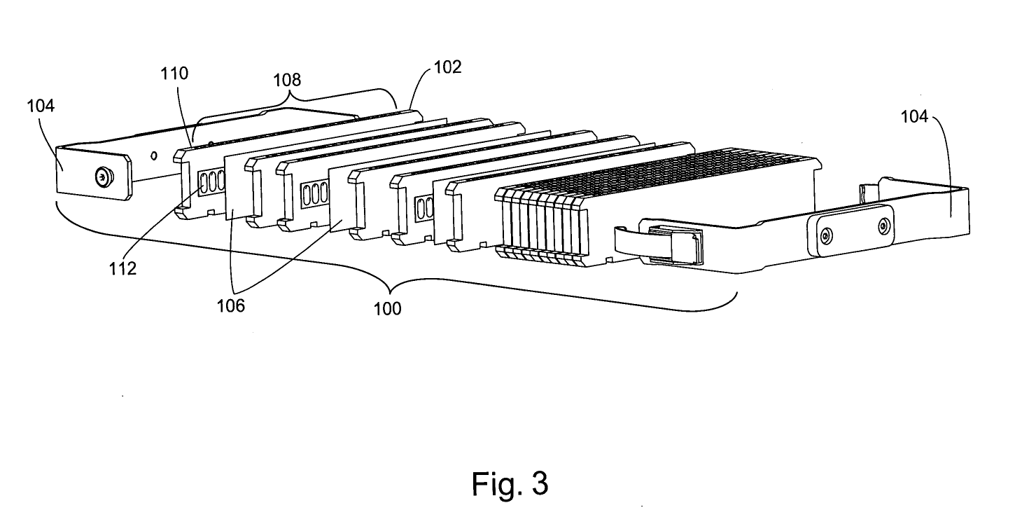

Referring initially to FIGS. 1-3, which schematically show multi-well container 100 from top, perspective, and exploded perspective views, respectively, according to one embodiment of the invention. As shown, multi-well container 100 includes multiple segments 102 (shown as separable blocks) attached to one another by clamping mechanism 104. Membranes 106 (e.g., strips of membrane) are disposed between adjacent pairs of segments 102 in multi-well container 100. Segment 102 includes line of wells 108 having multiple wells 110. In the embodiment shown, each well 110 communicates with a portion of chamber 112. In other embodiments, at least one well in a line of wells does not communicate with a portion of a chamber. In the assembled multi-well container 100 shown, for example, in FIGS. 1 and 2, consecutive pairs of segments 102 are mated together such that a portion of chamber 112 in one segment 102 corresponds to a portion of chamber 112 in the other segment 102 to thereby form the chamber. Optionally, a chamber communicates with more than two wells. Although other types of cavities are optionally utilized, the chambers shown, for example, in FIGS. 1-3, are formed as channels between pairs of wells in assembled multi-well container 100. As further shown in the embodiment schematically shown in FIGS. 1-3, surfaces of membrane 106 are disposed in the chamber so formed substantially normal to a bottom surface of the chamber, e.g., to eliminate potential bias introduced by gravity into various processes performed in the devices of the invention. The multi-well containers of the invention typically include n pairs of consecutive lines of wells and at least n membranes in which one or more membranes are disposed between each pair of consecutive lines of wells, where n is an integer greater than 0. Multi-well container 100, for example, includes eight pairs of consecutive lines of wells and eight membranes with one membrane disposed between each pair of consecutive lines of wells.

In some embodiments, the wells of the multi-well containers of the invention are sealed, e.g., when performing a given step of an assay, during device storage, and the like using a sealing component to minimize the risk of well contents becoming contaminated, to prevent the evaporation of fluids disposed in the wells, etc. Essentially any sealing component is optionally utilized. Exemplary sealing components include lids (e.g., fabricated from stainless steel, polymers, and/or other materials), adhesive tape, cap mats, and the like. To further illustrate, FIG. 2 also schematically shows sealing component 111 (shown as a lid) disposed above wells 110 of multi-well container 100 in a partially exploded perspective view.

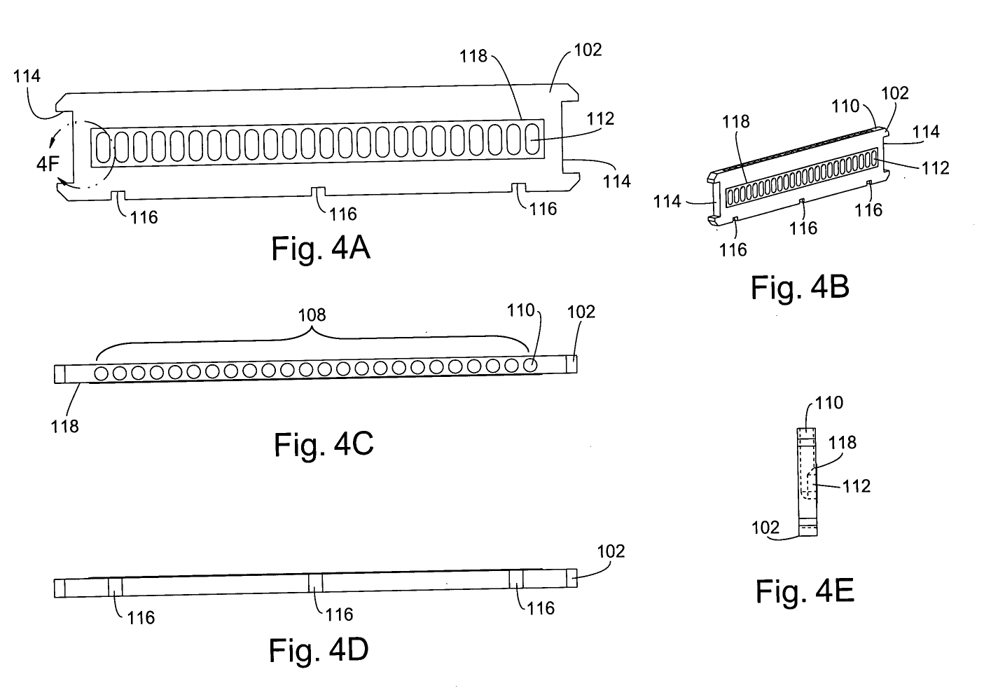

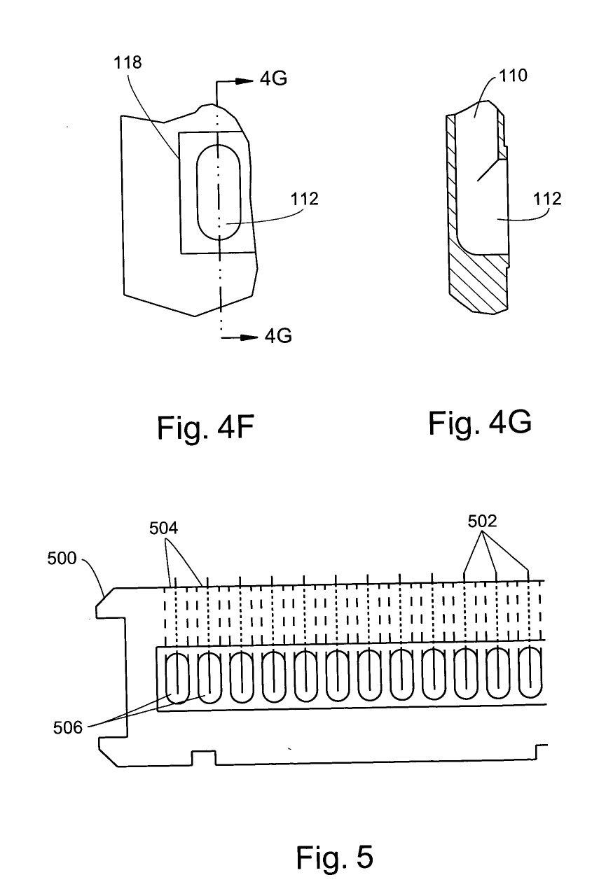

Now referring to FIGS. 4A-G, which schematically illustrate segment 102 from various views. In particular, FIGS. 4A-D schematically show segment 102 of multi-well container 100 from a side elevational view, a perspective view, a top view, and a bottom view, respectively. As shown, segment 102 includes recessed regions 114, which receive portions of clamping mechanism 104 to align multiple segments 102 relative to one another in an assembled multi-well container 100. Also shown are alignment notches 116 which align with corresponding alignment ridges disposed on a multi-well container support structure (not shown) during assembly of multi-well container 100 according to one embodiment of the invention. Multi-well container support structures are described further below. Chamber region 118, which includes the opening to portion of chamber 112 extends from a surface of segment 102 to further effect chamber sealing when membranes are disposed between mated container segments. In some embodiments, a container segment includes (e.g., in addition to or in lieu of elevated chamber region 118 ) male or female components (e.g., ridges, grooves, etc.) that correspond to female or male components of another container segment to further position the membrane and effect chamber sealing when the segments are mated with one another. FIG. 4E schematically depicts segment 102 from a transparent side elevational view to further illustrate portion of chamber 112 communicating with well 110. Further, FIG. 4F schematically shows a detailed view of portion of chamber 112 from segment 102, whereas FIG. 4G schematically illustrates a cross-sectional view through portion of the chamber 112.

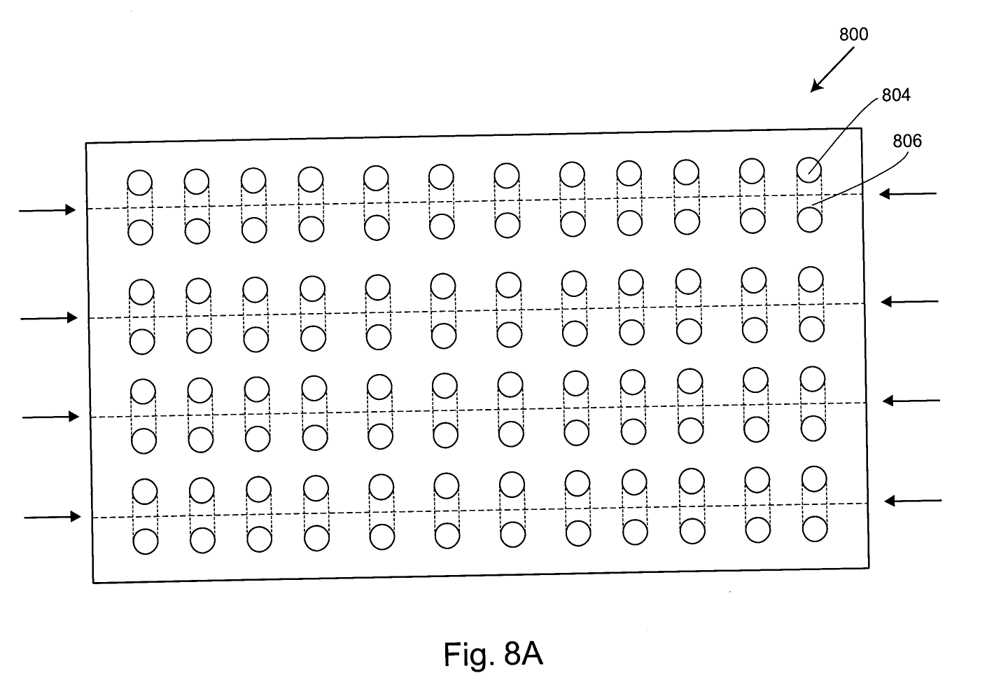

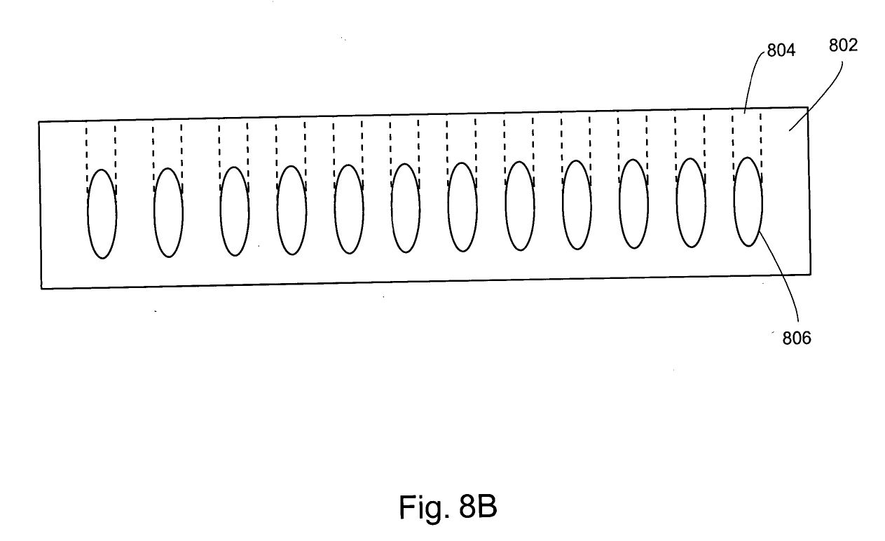

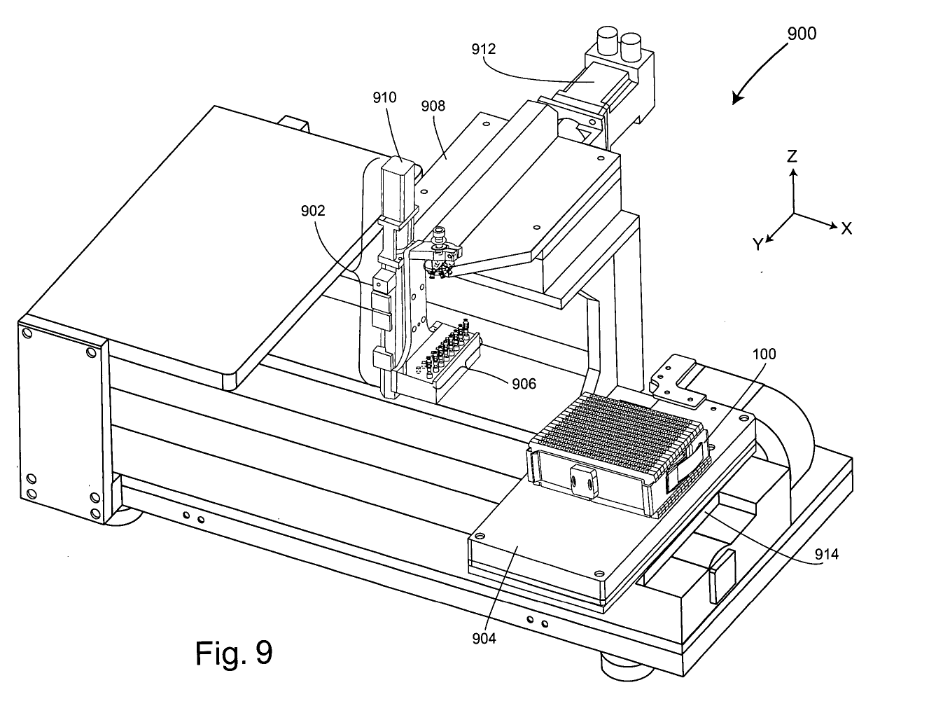

The multi-well containers of the invention typically include n segments and at least n/2 membranes in which one or more membranes are disposed between at least one pair of adjacent segments, where n is an integer greater than 1. To illustrate, multi-well containers typically include, e.g., 2, 3, 4, 5, 6, 7, 8, 9, 10, 11, 12, 13, 14, 15, 16, 17, 18, 19, 20, or more separable segments. Multi-well container 100 shown in FIGS. 1-3, for example, includes 16 separable segments 102 with one line of wells 108 per segment 102 and eight membranes 106. In other embodiments of the invention, segments include more than one line of wells per segment. This is schematically illustrated in, e.g., FIG. 8A, which shows multi-well container fabrication element 800 prior to being separated into segments 802 (see also, FIG. 8B). As shown, multi-well container fabrication element 800 includes 96 wells 804 in an 8×12 array in which the three interior segments 802 each include two lines of wells. The multi-well container that results from multi-well container fabrication element 800 upon fabrication is designed to have at least one membrane disposed between adjacent pairs of segments in the assembled device or a total of at least four membranes. Multi-well container fabrication element 800 and various fabrication techniques that are optionally utilized to fabricate the devices of the invention are described further below. To further illustrate, a 384-well container according to the present invention can also include segments having multiple lines of wells disposed thereon. For example, a 16×24-well array can be divided into nine segments such that the seven interior segments each include two lines of wells (24 wells each) and the remaining two segments each include one 24-well line of wells. This 384-well container typically includes eight membranes in the assembled device such that one membrane is disposed between each adjacent pair of segments. Many other multi-well container segment configurations beyond these specific illustrations can also be utilized in the devices of the invention and will be apparent to persons skilled in the art.

The segments of the multi-well containers of the invention are generally separable from one another along planes that are substantially vertically disposed through the containers. As referred to above, each segment typically includes a portion of the chamber. Typically, each segment includes at least one line of wells and at least portions of multiple chambers. In these embodiments, at least one of the portions of the chambers generally communicates with one or more wells disposed in the line of wells that are different from other wells disposed in the line of wells with which other portions of the chambers communicate. Further, the portions of the chambers disposed in at least a first segment optionally correspond to the portions of the chambers disposed in at least a second segment such that the corresponding portions of the chambers in the first and second segments communicate with one another when the multi-well container is assembled. This is illustrated, for example, in FIGS. 1-3, which are described further above.

The reaction blocks of the present invention optionally include various numbers and arrays of wells. For example, in certain embodiments multi-well containers include, e.g., 6, 12, 24, 48, 96, 192, 384, 768, 1536, or other numbers of wells. As shown in FIG. 1, for example, multi-well container 100 includes 384 wells arrayed in a rectangular 16×24 format. In certain embodiments, multi-well container well arrays have footprints that correspond to wells in standard micro-well plates (e.g., plates having 6, 12, 24, 48, 96, 192, 384, 768, 1536, or other numbers of wells). For example, the openings to wells in a multi-well container of the invention are optionally spaced at regular intervals, such as 9 mm centers for 96 well plates, 4.5 mm centers for 384 well plates, 2.25 mm centers for 1536 well plates, or the like. The overall dimensional area of a multi-well container of the invention generally provides a footprint of about the same size as a selected standard micro-well plate to permit interchangeable use of the multi-well container with standard equipment holders, automated well washers, X-Y-Z translational devices, or the like. It will be appreciated that the present invention may use any of a variety of arrays other than the format depicted in, e.g., FIG. 1, such as non-rectangular arrays of reaction wells and the like.

Multi-well container well dimensions (e.g., internal length or height, cross-sectional dimension/area, or the like) are typically selected according to the volume of fluidic material desired for containment within a particular well. For example, wells of the present invention generally include volume capacities of between about 0.1 ml and about 100 ml, typically between about 1 ml and about 50 ml, more typically between about 1 ml and about 25 ml, and still more typically between about 1 ml and about 2 ml. Optionally, wells are designed to accommodate fluid volumes in excess of about 100 ml. In certain embodiments, different wells in a given reaction block include different fluid volume capacities. In other embodiments, each well in a device of the invention includes about the same fluid volume capacity. In addition, at least a segment of a well and an a chamber of a multi-well container of the invention optionally includes an inner cross-sectional shape independently selected from, e.g., a regular n-sided polygon, an irregular n-sided polygon, a triangle, a square, a rounded square, a rectangle, a rounded rectangle, a trapezoid, a circle, an oval, or the like. Rounded internal well and/or chamber surfaces generally reduce undesirable fluid wicking that can occur with angled internal well surfaces.

In some embodiments, multi-well containers include electrodes disposed in electrical communication with the wells and/or chambers, e.g., to apply a voltage between the electrodes when the electrodes are operably connected to a power supply. Electrodes so disposed can be used, e.g., to effect electrodialysis in the wells and/or chambers, to elute biomolecules (e.g., nucleic acids, proteins, etc.) from gels disposed within the wells, to resistively heat materials disposed in the wells and/or chambers, and/or the like. To illustrate an embodiment of this aspect of the invention, FIG. 5 schematically shows a portion of multi-well container segment 500 having electrodes 502 disposed in electrical communication with wells 504 and chamber portions 506 from a side elevational view. Electrodes can be fabricated from essentially any electrically conductive material including, e.g., platinum, copper, and the like. Additional details relating to electrodes and suitable power sources are provided in, e.g., Rizzoni, Principles and Applications of Electrical Engineering, 3^{rd} Ed., McGraw-Hill Higher Education (2000), Skoog et al.,Principles of Instrumental Analysis, 5^{th} Ed., Harcourt Brace College Publishers (1998), and Currell, Analytical Instrumentation: Performance Characteristics and Quality, John Wiley & Sons, Inc. (2000), which are each incorporated by reference in their entirety.

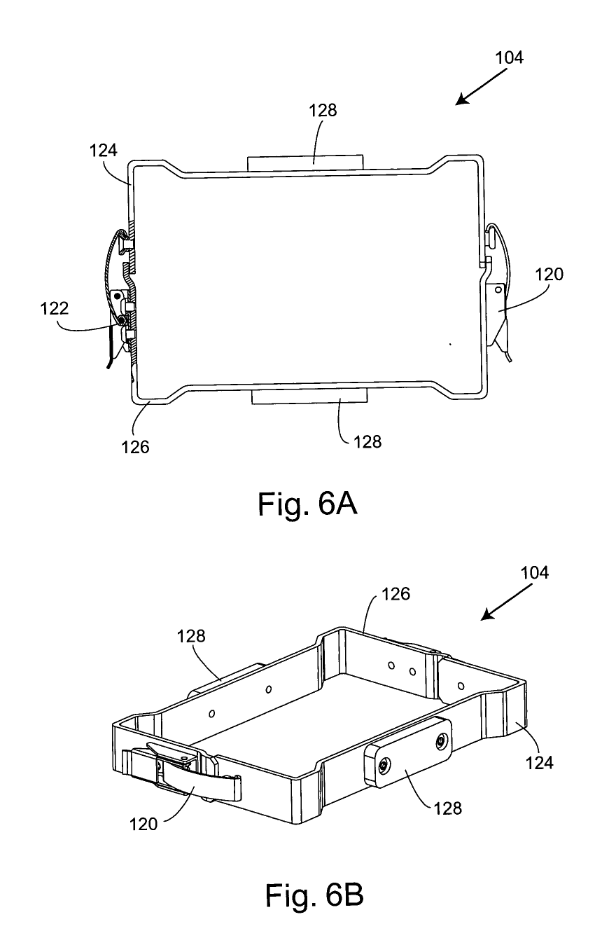

Multi-well container segments are optionally attached to one another in an assembled multi-well container using essentially any attachment technique such that membranes are securely positioned between mated container segments. Exemplary attachment techniques are optionally selected from, e.g., bonding the segments together, adhering the segments together, bolting the segments together, screwing the segments together, clamping the segments together, and the like. To further illustrate, FIGS. 6 A and B schematically depict clamping mechanism 104 of multi-well container 100 from a top view and a perspective view, respectively. As shown, clamping mechanism 104 includes clamps 120 and 122, which clamp support band portions 124 and 126 together. FIG. 6A schematically depicts a partial cutaway view of regions of support band portions 124 and 126 proximal to clamp 122 and of clamp 122 to illustrate a cross-sectional view through those components of multi-well container 100. As mentioned above, recessed regions 114 of container segments 102 receive sections of support band portions 124 and 126 when multi-well container 100 is assembled. FIGS. 6 A and B also schematically show alignment components 128 attached to support band portions 124 and 126. Alignment components 128 are optionally included to provide a substantially straight edge with which to align multi-well container 100 with another component, such as a positioning component, robotic gripping arms, and/or the like. Positioning components, robotic gripping apparatus, and other system components are described further below. In other embodiments of the invention, alignment components 128 are not included. For example, support band portions 124 and 126 of clamping mechanism 104 are optionally fabricated with continuously straight edges. Other exemplary attachment techniques include disposing rods through portions of multi-well container segments to align the segments relative to one another, which rods include male or female threaded ends that can receive nuts, screws, or the like to attach the segments to one another in an assembled device.

In some embodiments, multi-well container segments and membranes are removably attached to one another in an assembled device such that at least some of these components can be reused in multiple applications. In these embodiments, multi-well containers can be disassembled, e.g., following use to wash the container segments and/or membranes, to replace damaged segments and/or membranes, and/or the like. In other embodiments, multi-well container segments and membranes are not separable from one another, e.g., following fabrication. In some of these embodiments, for example, multi-well container segments and membranes are bonded or otherwise more permanently attached to one another in an assembled device. In these embodiments, multi-well containers are typically intended to be disposable or otherwise not intended for indefinite usage.

Essentially any membranous material is optionally adapted for use in a multi-well container of the invention, e.g., in the form of strips that can be positioned between container segments in an assembled device. Semi-permeable membranes are typically used in the multi-well containers described herein. Suitable semi-permeable membranes generally include pore sizes of at least about 1 nm. For example, semi-permeable membranes optionally utilized in the devices of the invention include pore sizes of between about 1 μm and about 100 μm, typically between about 5 μm and about 50 μm, and more typically between about 10 μm and about 25 μm. To further illustrate, suitable membranes are optionally selected from, e.g. polyaramide membranes, polycarbonate membranes, porous plastic matrix membranes (e.g., POREX® Porous Plastic, etc.), porous metal matrix membranes, polyethylene membranes, poly(vinylidene difluoride) membranes, polyamide membranes, nylon membranes, ceramic membranes, polyester membranes, polytetrafluoroethylene (TEFLON®) membranes, woven mesh membranes, microfiltration membranes, nanofiltration membranes, ultrafiltration membranes, dialysis membranes, composite membranes, hydrophilic membranes, hydrophobic membranes, polymer-based membranes, a non-polymer-based membranes, powdered activated carbon membranes, polypropylene membranes, glass fiber membranes, glass membranes, nitrocellulose membranes, cellulose membranes, cellulose nitrate membranes, cellulose acetate membranes, polysulfone membranes, polyethersulfone membranes, polyolefin membranes, or the like. Many of these membranous materials are widely available from various commercial suppliers, such as, P.J. Cobert Associates, Inc. (St. Louis, Mo.), Millipore Corporation (Bedford, Mass.), or the like. Additional details regarding filtration and membranes are described in various publications including, e.g., Ho and Sirkar (Eds.), Membrane Handbook, Van Nostrand Reinhold (1992), Cheryan, Ultrafiltration and Microfiltration Handbook, 2^{nd} Ed., Technomic Publishing Company (1998), and Mulder, Basic Principles of Membrane Technology, 2^{nd} Ed., Dordrecht: Kluwer (1996).

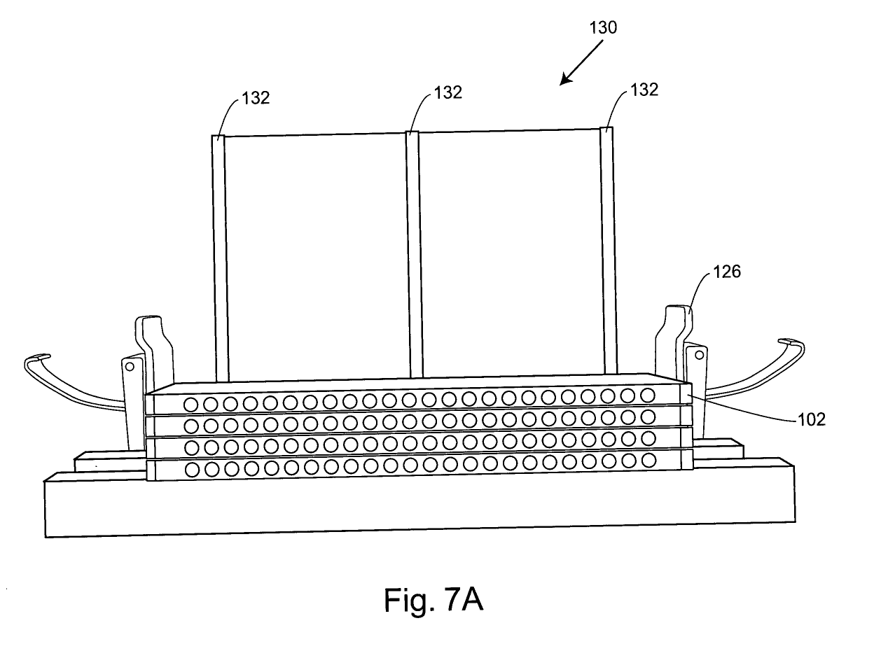

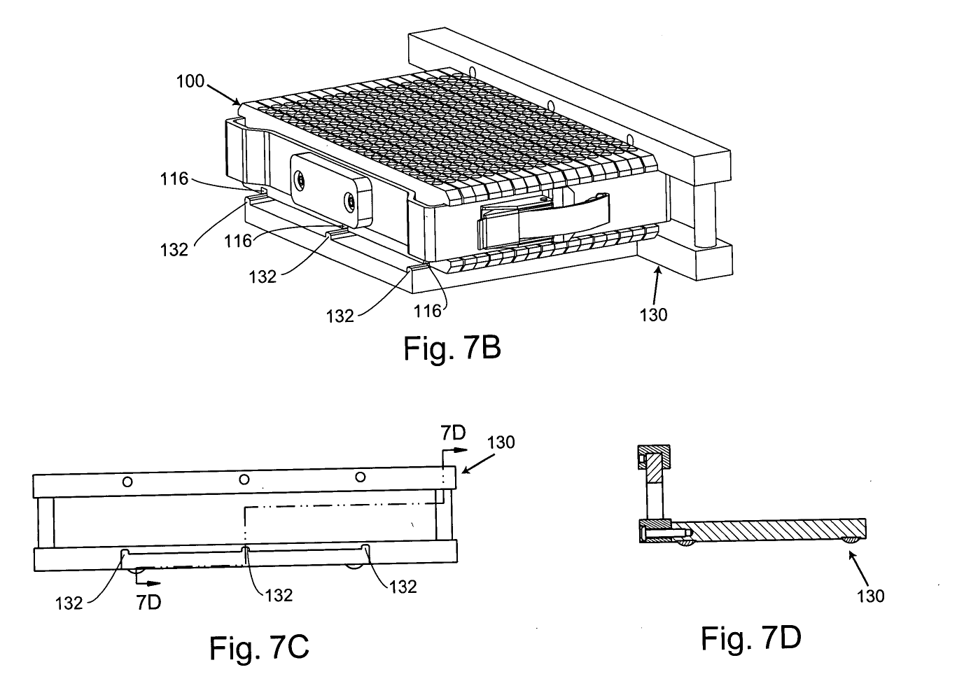

In certain embodiments of the invention, multi-well containers are assembled in a support structure that supports, e.g., the clamping mechanism, container segments, and membranes during the assembly process. Optionally, the multi-well containers described herein are not supported by a support structure during device assembly. FIGS. 7A-D schematically show a multi-well container support structure according to one embodiment of the invention. More specifically, FIG. 7A schematically illustrates multi-well container support structure 130 having partially assembled multi-well container 100 disposed thereon from a side view. Further, FIG. 7B schematically shows multi-well container support structure 130 having assembled multi-well container 100 from a perspective view. As shown, multi-well container support structure 130 includes alignment ridges 132 which correspond to alignment notches 116 (described above) of segments 102 of multi-well container 100 to further align segments 102 during device assembly. FIG. 7C schematically depicts multi-well container support structure 130 from a top view, whereas FIG. 7D schematically shows a cross-sectional view through multi-well container support structure 130.

Multi-well container components and other components of the devices (e.g., multi-well container support structures, etc.) and systems described herein are fabricated from materials that are generally selected according to properties, such as reaction inertness, durability, expense, or the like. In certain embodiments, for example, device components, such as multi-well container segments are fabricated from various polymeric materials such as, polytetrafluoroethylene (TEFLON®), perfluoroalkoxy (PFA), fluorinated ethylene propylene (FEP), polypropylene, polystyrene, polystyrene/acrylonitrile copolymer, polysulfone, polyethersulfone, polyethylene, polymethylpentene, polydimethylsiloxane (PDMS), polycarbonate, polyvinylchloride (PVC), polymethylmethacrylate (PMMA), cellulose acetate, or the like. Polymeric parts are typically economical to fabricate, which affords multi-well container component disposability (e.g., replacing the container segments without replacing other device or system components, such as clamping components, multi-well container support structures, etc.). Multi-well containers or component parts thereof are also optionally fabricated from other materials including, e.g., glass, metal (e.g., stainless steel, anodized aluminum, etc.), silicon, or the like. For example, multi-well containers are optionally assembled from a combination of materials permanently or removably joined or fitted together, e.g., polymer or glass multi-well container segments with stainless steel clamping mechanisms, etc.

The multi-well containers or components thereof are optionally formed by various fabrication techniques or combinations of such techniques including, e.g., injection molding, cast molding, machining, embossing, extrusion, etching, or other techniques. These and other suitable fabrication techniques are generally known in the art and described in, e.g., Rosato, Injection Molding Handbook, 3^{rd} Ed., Kluwer Academic Publishers (2000), Fundamentals of Injection Molding, W. J. T. Associates (2000), Whelan, Injection Molding of Thermoplastics Materials, Vol. 2, Chapman & Hall (1991), Fisher, Extrusion of Plastics, Halsted Press (1976), and Chung, Extrusion of Polymers: Theory and Practice, Hanser-Gardner Publications (2000). After multi-well container or component part fabrication, the containers or components thereof, such as container segments or portions thereof (e.g., wells, chambers, etc.), etc., are optionally further processed, e.g., by coating surfaces with, e.g., a hydrophilic coating, a hydrophobic coating (e.g., a polytetrafluoroethylene (i.e., TEFLON®) coating or the like), e.g., to provide non-adsorbing and/or non-reactive surfaces.

More specifically, one representative method of fabricating a multi-well container includes providing a multi-well container fabrication element (e.g., produced using an injection or cast molding process, etc.) that includes at least two wells disposed through a surface of the multi-well container fabrication element and at least one chamber disposed in the multi-well container fabrication element. The chamber communicates with the wells. The method also includes separating the multi-well container fabrication element into at least two segments using at least one separation technique known in the art in which each segment includes at least one well and at least a portion of the chamber. In addition, the method also includes disposing at least one membrane over the portion of the chamber disposed in at least one of the segments, and attaching the segments together using at least one attachment technique described herein or otherwise known in the art such that the membrane is disposed in the chamber between the wells. To further illustrate the method, FIG. 8A schematically shows a transparent multi-well container fabrication element 800 from a top view prior to being separated into segments 802 (shown in FIG. 8B). As shown, multi-well container fabrication element 800 includes multiple lines of wells. Wells 804 communicate with chamber 806 disposed in multi-well container fabrication element 800. The arrows indicate the vertical planes along which multi-well container fabrication element 800 is to be separated in this embodiment. Note in this embodiment that upon separation certain segments 802 will include multiple lines of wells. FIG. 8B schematically illustrates segment 802 after being separated from multi-well container fabrication element 800 from a transparent side elevational view.

In some embodiments of the methods of fabricating multi-well containers, the wells are initially fabricated as clearance holes that are disposed completely through multi-well container fabrication elements. After segmenting the fabrication elements, disposing membranes between the segments, and attaching the segments together, as described above, the bottom surfaces of the wells are formed by applying a cap mat, a clear film, or the like to a surface of the device that comprises the holes, e.g., using an adhesive or another attachment technique. In certain embodiments, multi-well containers having wells with clear bottoms are used to perform assays in which well contents are imaged, e.g., using charge-coupled devices (CCDs) or other detection components. Additional details relating to detection components are provided below.

III. Multi-well Container Processing Systems

The multi-well containers of the invention are optionally included as components of systems, e.g., for performing various assays (e.g., high throughput screening protocols, etc.) and/or syntheses (e.g., combinatorial library synthesis reactions, etc.) in the wells of the containers. The systems of the invention are typically highly automated and optionally include various components that are selected according to the particular procedures to be performed in the multi-well containers. To illustrate, a system typically includes a multi-well container as described herein and a fluid handling component that includes at least one fluid handler (e.g., a dispenser, an aspirator, and/or the like) that is structured to dispense and/or aspirate fluidic materials into and/or from wells of the multi-well container. Typically, the fluid handling component includes multiple fluid handlers in which at least two of the fluid handlers are spaced at a distance that substantially corresponds to a distance between two or more wells disposed in the multi-well container, e.g., to simultaneously dispense and/or aspirate fluidic materials from multiple wells. In some of these embodiments, the fluid handling component is hand-held (e.g., a hand-held pipettor, etc.), whereas in others, the fluid handling component comprises a translocation device that translocates the fluid handler and the multi-well container relative to one another. In certain embodiments, the multi-well container further includes a positioning component that is structured to position the multi-well container relative to the fluid handling component. Optionally, the multi-well container further includes a thermal regulator operably connected to (whether integral with or separate from) the multi-well container. The thermal regulator regulates temperature in the wells and chamber, e.g., when a given assay or synthesis is performed in the multi-well container. Integral thermal regulators that are optionally adapted for use in the multi-well containers of the invention are described further in, e.g., U.S. Pat. No. 6,423,948, entitled “MICROTITER PLATE WITH INTEGRAL HEATER,” which issued Jul. 23, 2003 to Kwasnoski et al., which is incorporated by reference in its entirety. As also described above, multi-well containers optionally further include electrodes disposed in electrical communication with the wells and/or chambers of the containers, e.g., to effect electrodialysis, resistive heating, and/or the like in the devices. In these embodiments, the multi-well containers generally further include electrical power sources operably connected to the electrodes to apply a voltage between electrodes when conductive material is disposed in the wells and chambers of the multi-well containers. Various other components are also optionally included in the systems of the invention. Many of these are described further below.

To further illustrate the systems of the invention, FIG. 9 schematically illustrates multi-well container processing system 900 that includes fluid handling component 902 and positioning component 904 from a perspective view according to one embodiment of the invention. As shown, multi-well container processing system 900 includes fluid handlers 906 mounted on Y- and Z-axis translocation component 908. Translocation component 908 is structured to translocate fluid handlers 906 (e.g., dispensing tips, etc.) and/or other components such as material removal components along the Z-axis, e.g., to dispense and/or remove materials to and/or from multi-well container 100. Material removal components that are optionally adapted for use in the systems of the invention are described further in, e.g., U.S. Provisional Patent Application No. 60/461,638, entitled “MATERIAL REMOVAL DEVICES, SYSTEMS, AND METHODS,” filed Apr. 8, 2003 by Micklash II, et al., which is incorporated by reference in its entirety. Translocation component 908 is also structured to translocate these components along the Y-axis, e.g., to move fluid handling component 902 across multi-well container 100. More specifically, drive mechanism 910 effects Z-axis translation, whereas drive mechanism 912 effects Y-axis movement of fluid handling component 902 and/or other components. Drive mechanism 910 and 912 are typically servo motors, stepper motors, or the like. Although not shown in FIG. 9, a tube or other conduit operably connects fluid handling component 902 to one or more fluidic material sources and to a fluid direction component (e.g., peristaltic pumps, syringe pumps, bottle valves, and/or the like) that conveys the fluidic materials from the sources and/or from multi-well container 100. At least one valve (e.g., a solenoid valve, etc.) that is structured to regulate fluid flow from the fluidic material sources is generally operably connected to fluid handling component 902 and/or the tube. In addition, one or more traps (e.g., fluid traps, containers, filters, etc.) are optionally disposed in the fluid line between fluid handling component 902 or when present, a separate material removal component and the fluidic material sources to trap and store materials (e.g., waste materials or the like) removed from multi-well container 100 for subsequent disposal. Fluid handling components for handling fluids in multi-well containers, which are optionally adapted for use in the systems of the present invention are described further in, e.g., International Publication No. WO 02/076830, entitled “MASSIVELY PARALLEL FLU LID DISPENSING SYSTEMS AND METHODS,” filed Mar. 27, 2002 by Downs et al., which is incorporated by reference in its entirety.

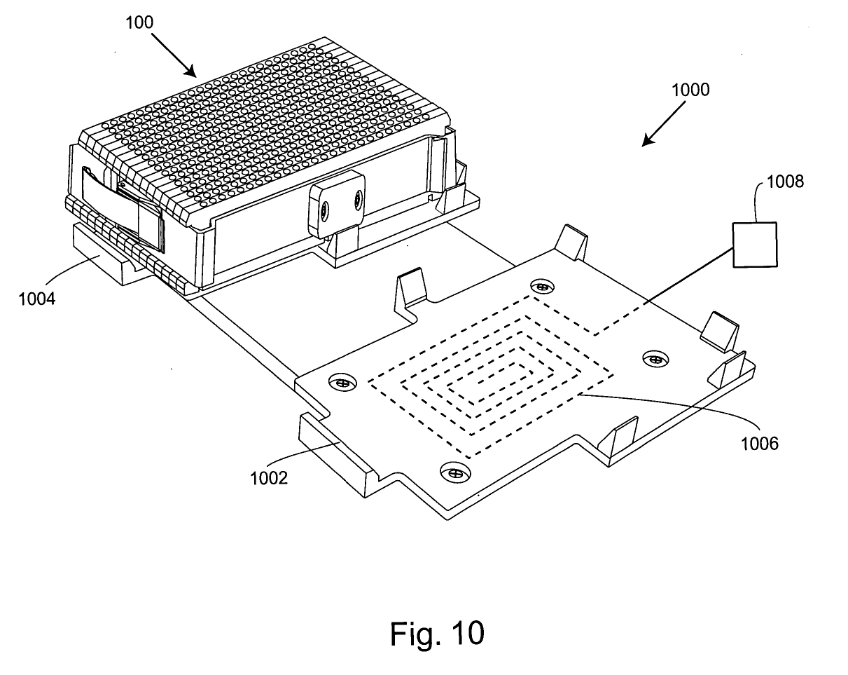

As also shown in FIG. 9, multi-well container processing system 900 includes positioning component 904, which precisely positions multi-well container 100 relative to fluid handling component 902 so that materials can be removed from and/or dispensed into selected wells of multi-well container 100. Positioning component 904 is mounted on X-axis translocation component 914, which moves (e.g., slides) positioning component 904 along the X-axis to align wells disposed in multi-well container 100 with, e.g., fluid handlers 906 of fluid handling component 902. A drive mechanism (not shown), such as a servo motor, a stepper motor, or the like, is generally operably connected to X-axis translocation component 914 to effect movement of positioning component 904 and/or other components. Typically, the positioning components of the invention include appropriate mounting/alignment structural elements, such as alignment pins and/or holes, nesting wells, or the like, e.g., to facilitate proper alignment of multi-well containers with system components. Many other types of positioning components are also optionally adapted for use in the systems of the invention. For example, FIG. 10 schematically shows positioning component 1000 from a perspective view according to one embodiment of the invention. As shown, positioning component 1000 includes nests 1002 and 1004 for positioning multi-well containers of the invention. In particular, FIG. 10 shows multi-well container 100 positioned in nest 1004. As further shown, positioning component 1000 includes thermal regulator 1006 (e.g., a heating element or coil, etc.) disposed within nest 1002. Thermal regulator 1006 is typically operably connected to power supply 1008 to regulate temperature in a multi-well container of the invention when the container is positioned in nest 1002. Additional details relating to positioning components that can be utilized in the systems of the invention are described in, e.g., International Publication No. WO 01/96880, entitled “AUTOMATED PRECISION OBJECT HOLDER,” filed Jun. 15, 2001 by Mainquist et al. and U.S. Provisional Patent Application No. 60/492,586, entitled “MULTI-WELL CONTAINER POSITIONING DEVICES AND RELATED SYSTEMS AND METHODS,” filed Aug. 4, 2003 by Evans, which are both incorporated by reference in their entirety.

The systems of the invention optionally further include various incubation components and/or multi-well container storage components. In some embodiments, for example, systems include incubation components that are structured to incubate or regulate temperatures within multi-well containers. To illustrate, many cell-based or other types of assays include incubation steps and can be performed using these systems. Additional details regarding incubation devices that are optionally adapted for use with the systems of the present invention are described in, e.g., International Publication No. WO 03/008103, entitled “HIGH THROUGHPUT INCUBATION DEVICES,” filed Jul. 18, 2002 by Weselak et al., which is incorporated by reference in its entirety. In certain embodiments, multi-well container processing systems of the invention include multi-well container storage components that are structured to store one or more multi-well containers. Such storage components typically include multi-well container hotels, stackers, or carousels that are known in the art and readily available from various commercial suppliers, such as Beckman Coulter, Inc. (Fullerton, Calif.). For example, in one embodiment, a multi-well container processing system of the invention includes a stand-alone station in which a user loads a number of multi-well containers to be processed into one or more storage components of the system for automated processing of the containers. In these embodiments, the systems of the invention also typically include one or more robotic gripper apparatus that move containers, e.g., between incubation or storage components and positioning components. Robotic grippers that are suitable for use in the systems of the invention are described further below or otherwise known in the art. For example, a TECAN® robot, which is commercially available from Clontech (Palo Alto, Calif.), is optionally adapted for use in the systems described herein.

In some embodiments, shaking devices and/or centrifuges are included in the systems of the invention to agitate and/or centrifuge the contents of wells disposed in the multi-well containers described herein. Many shaking devices and/or centrifuges that are optionally adapted for use in the systems of the invention are available from various commercial suppliers including, e.g., Beckman Coulter, Inc. (Fullerton, Calif.), Sigma-Aldrich Corporation (St. Louis, Mo.), Zymark Corporation (Hopkinton, Mass.), Bellco Glass, Inc. (Vineland, N.J.), and the like. Additional details relating to centrifugation are also provided in, e.g., International Publication No. WO 02/062484, entitled “AUTOMATED CENTRIFUGE AND METHOD OF USING SAME,” filed Feb. 8, 2002 by Downs et al., which is incorporated by reference in its entirety.

In certain embodiments, the systems of the invention also include at least one detection component that is structured to detect detectable signals produced, e.g., in wells of multi-well containers. Suitable signal detectors that are optionally utilized in these systems detect, e.g., fluorescence, phosphorescence, radioactivity, mass, concentration, pH, charge, absorbance, refractive index, luminescence, temperature, magnetism, or the like. Detectors optionally monitor one or a plurality of signals from upstream and/or downstream of the performance of, e.g., a given assay step. For example, the detector optionally monitors a plurality of optical signals, which correspond in position to “real time” results. Example detectors or sensors include photomultiplier tubes, CCD arrays, optical sensors, temperature sensors, pressure sensors, pH sensors, conductivity sensors, scanning detectors, or the like. Each of these as well as other types of sensors are optionally readily incorporated into the systems described herein. The detector optionally moves relative to multi-well containers or other assay components, or alternatively, multi-well containers or other assay components move relative to the detector. In certain embodiments, for example, detection components are coupled to translation components that move the detection components relative to multi-well containers positioned on positioning components of the systems described herein. Optionally, the systems of the present invention include multiple detectors. In these systems, such detectors are typically placed either in or adjacent to, e.g., a multi-well container or other vessel, such that the detector is within sensory communication with the multi-well container or other vessel (i.e., the detector is capable of detecting the property of the container or vessel or portion thereof, the contents of a portion of the container or vessel, or the like, for which that detector is intended).

The detector optionally includes or is operably linked to a computer, e.g., which has system software for converting detector signal information into assay result information or the like. For example, detectors optionally exist as separate units, or are integrated with controllers into a single instrument. Integration of these functions into a single unit facilitates connection of these instruments with the computer, by permitting the use of few or a single communication port(s) for transmitting information between system components. Computers and controllers are described further below. Detection components that are optionally included in the systems of the invention are described further in, e.g., Skoog et al., Principles of Instrumental Analysis, 5^{th} Ed., Harcourt Brace College Publishers (1998) and .Currell, Analytical Instrumentation: Performance Characteristics and Quality, John Wiley & Sons, Inc. (2000), which are incorporated by reference in their entirety for all purposes.

The systems of the invention optionally also include at least one robotic gripping component that is structured to grip and translocate multi-well containers between components of the multi-well container processing systems and/or between the multi-well container processing systems and other locations (e.g., other work stations, etc.). In certain embodiments, for example, systems further include gripping components that move multi-well containers between positioning components, incubation components, and/or detection components. A variety of available robotic elements (robotic arms, movable platforms, etc.) can be used or modified for use with these systems, which robotic elements are typically operably connected to controllers that control their movement and other functions. Exemplary robotic gripping devices that are optionally adapted for use in the systems of the invention are described further in, e.g., U.S. Pat. No. 6,592,324, entitled “GRIPPER MECHANISM,” which issued Jul. 15, 2003 to Downs et al. and International Publication No. WO 02/068157, entitled “GRIPPING MECHANISMS, APPARATUS, AND METHODS,” by Downs et al., which are both incorporated by reference in their entirety.

The multi-well container processing systems of the invention also typically include controllers that are operably connected to one or more components (e.g., solenoid valves, pumps, translocation components, positioning components, etc.) of the system to control operation of the components. More specifically, controllers are generally included either as separate or integral system components that are utilized, e.g., to regulate pressure applied by pressure sources at fluid handler inlets, the quantities of samples, reagents, cleaning fluids, or the like dispensed from fluid handlers, the movement of translocation components, e.g., when positioning multi-well containers relative to fluid handlers, etc. Controllers and/or other system components is/are optionally coupled to an appropriately programmed processor, computer, digital device, or other information appliance (e.g., including an analog to digital or digital to analog converter as needed), which functions to instruct the operation of these instruments in accordance with preprogrammed or user input instructions, receive data and information from these instruments, and interpret, manipulate and report this information to the user.

Any controller or computer optionally includes a monitor which is often a cathode ray tube (“CRT” ) display, a flat panel display (e.g., active matrix liquid crystal display, liquid crystal display, etc.), or others. Computer circuitry is often placed in a box, which includes numerous integrated circuit chips, such as a microprocessor, memory, interface circuits, and others. The box also optionally includes a hard disk drive, a floppy disk drive, a high capacity removable drive such as a writeable CD-ROM, and other common peripheral elements. Inputting devices such as a keyboard or mouse optionally provide for input from a user.

The computer typically includes appropriate software for receiving user instructions, either in the form of user input into a set of parameter fields, e.g., in a GUI, or in the form of preprogrammed instructions, e.g., preprogrammed for a variety of different specific operations. The software then converts these instructions to appropriate language for instructing the operation of one or more controllers to carry out the desired operation, e.g., varying or selecting the rate or mode of movement of various system components, directing translation of robotic gripping apparatus, fluid handlers, or of one or more multi-well containers or other vessels, or the like. The computer then receives the data from, e.g., sensors/detectors included within the system, and interprets the data, either provides it in a user understood format, or uses that data to initiate further controller instructions, in accordance with the programming, e.g., such as in monitoring incubation temperatures, detectable signal intensity, or the like.

The computer can be, e.g., a PC (Intel x86 or Pentium chip-compatible DOS™, OS2™, WINDOWS™, WINDOWS NT™, WINDOWS95™, WINDOWS98™, WINDOWS2000™, WINDOWS XP™, LINUX-based machine, a MACINTOSH™, Power PC, or a UNIX-based (e.g., SUN^{TM} work station) machine) or another common commercially available computer that is known to one of skill. Standard desktop applications such as word processing software (e.g., Microsoft Word™ or Corel WordPerfect™) and database software (e.g., spreadsheet software such as Microsoft Excel™, Corel Quattro Pro™, or database programs such as Microsoft Access^{TM} or Paradox™) can be adapted to the present invention. Software for performing, e.g., material removal from selected wells of a multi-well plate is optionally constructed by one of skill using a standard programming language such as Visual basic, Fortran, Basic, Java, or the like.

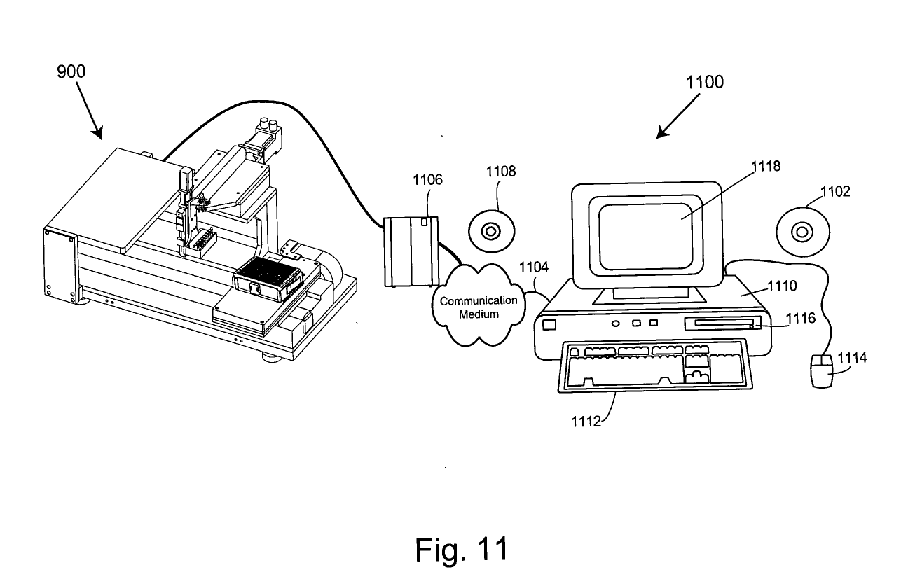

FIG. 11 is a schematic showing a representative example multi-well container processing system including an information appliance in which various aspects of the present invention may be embodied. As will be understood by practitioners in the art from the teachings provided herein that the invention is optionally implemented in hardware and software. In some embodiments, different aspects of the invention are implemented in either client-side logic or server-side logic. As will also be understood in the art, the invention or components thereof may be embodied in a media program component (e.g., a fixed media component) containing logic instructions and/or data that, when loaded into an appropriately configured computing device, cause that apparatus or system to perform according to the invention. As will additionally be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

FIG. 11 shows information appliance or digital device 1100 that may be understood to be a logical apparatus (e.g., a computer, etc.) that can read instructions from media 1102 and/or network port 1104, which can optionally be connected to server 1106 having fixed media 1108. Information appliance 1100 can thereafter use those instructions to direct server or client logic, as understood in the art, to embody aspects of the invention. One type of logical apparatus that may embody the invention is a computer system as illustrated in 1100, containing CPU 1110, optional input devices 1112 and 1114, disk drives 1116 and optional monitor 1118. Fixed media 1102, or fixed media 1108 over port 1104, may be used to program such a system and may represent a disk-type optical or magnetic media, magnetic tape, solid state dynamic or static memory, or the like. In specific embodiments, aspects of the invention may be embodied in whole or in part as software recorded on this fixed media. Communication port 1104 may also be used to initially receive instructions that are used to program such a system and may represent any type of communication connection. Optionally, aspects of the invention are embodied in whole or in part within the circuitry of an application specific integrated circuit (ACIS) or a programmable logic device (PLD). In such a case, aspects of the invention may be embodied in a computer understandable descriptor language, which may be used to create an ASIC, or PLD. FIG. 11 also includes multi-well container processing system 900, which is operably connected to information appliance 1100 via server 1106. Optionally, multi-well container processing system 900 is directly connected to information appliance 1100. During operation, multi-well container processing system 900 typically dispenses and/or removes fluidic materials from selected wells of multi-well containers positioned on positioning component 904 of multi-well container processing system 900, e.g., as part of an analytical and/or synthetic process performed in the container.

IV. Kits

The invention also provides kits that include at least one multi-well container described herein, or components of such a container. The multi-well containers of the kits of the invention are optionally packaged pre-assembled or unassembled (e.g., with separate segments, membranes, and attachment components). Kits are optionally packaged to further include reagents and control /calibrating materials for performing selected assays and/or syntheses in the multi-well containers of the invention. In the case of pre-packaged reagents, the kits optionally include pre-measured or pre-dosed reagents that are ready to incorporate into a particular protocol without measurement, e.g., pre-measured fluid aliquots, or pre-weighed or pre-measured solid reagents that can be easily reconstituted by the end-user of the kit. Generally, reagents are provided in a stabilized form, so as to prevent degradation or other loss during prolonged storage, e.g., from leakage. A number of stabilizing processes are widely used for reagents that are to be stored, such as the inclusion of chemical stabilizers (i.e., enzymatic inhibitors, microcides/bacteriostats, anticoagulants), the physical stabilization of the material, e.g., through immobilization on a solid support, entrapment in a matrix (i.e., a gel), lyophilization, or the like. In certain embodiments, kits include only selected components, such as segments, membranes, clamping or other attachment mechanisms, multi-well container support structures, or other components. Kits typically include appropriate instructions for assembling/disassembling, utilizing, and maintaining the multi-well containers or components thereof. Kits also typically include packaging materials or containers for holding kit components.

V. Multi-well Container-based Methods

Various analytic and/or synthetic processes can be performed or adapted for performance in the multi-well containers and related systems of the invention by persons of skill in the art. Accordingly, no attempt is made herein to describe all of the possible uses of the multi-well containers of the invention beyond certain exemplary methods that are provided to further illustrate the invention, but not to limit the present invention. In particular, one exemplary binding assay that can be performed in the multi-well containers of the invention includes dispensing at least a first fluid into a first of two wells that communicate with one another via a chamber having a semi-permeable membrane disposed therein. The first fluid (e.g., serum, plasma, etc.) typically includes at least a first component (described further below). Optionally, the first component is immobilized on a cellular membrane or on a surface of the first of the two wells. In some embodiments, a cell population includes the first component (e.g., displayed on the surfaces of cells in the population, etc.), which cell population is dispensed into the first of the two wells in the first fluid. In some of these embodiments, the cell population is grown in the first of the two wells prior to dispensing other materials into the first or the second of the two wells. Cell and tissue culturing is described further below.

The method also includes dispensing at least a second fluid into the first and/or the second of the two wells. The second fluid includes at least a second component. Exemplary first and second components are optionally independently selected from, e.g., organic molecules, inorganic molecules, ligands, drugs, polynucleotides, polypeptides, peptides, enzymes, receptors, antibodies, antigens, neurotransmitters, cytokines, chemokines, hormones, lipids, carbohydrates, and the like. Typically, at least some unbound second component flows through the semi-permeable membrane from one well to the other well, e.g., to establish equilibrium between the wells. In addition, the method also includes determining whether the first component binds to the second component. Concentrations of unbound second component in the first and second wells are typically allowed to equilibrate prior to performing the determining step. In some embodiments, the method further includes dispensing at least a third fluid (e.g., a buffer, etc.) into the first or the second of the two wells. In certain embodiments, the method further includes dispensing at least one modulator into the first or second well before or after dispensing the second fluid into the first or second of the two wells. The modulator modulates binding of the first and second components to one another. Optionally, the method further includes heating, centrifuging, ,and/or shaking the fluids in the wells. An example that illustrates binding assays performed in the multi-well containers of the invention is provided below.

In certain embodiments, the determining step includes detecting at least one detectable signal that indicates a concentration of unbound first component or unbound second component. In some embodiments, the detectable signal that indicates the concentration of the unbound first component or the unbound second component is detected multiple times when performing the binding assay, e.g., to monitor binding over time. Optionally, the detectable signal is detected in the first well, in the second well, or in both the first and second wells. Exemplary detectable signals optionally include, e.g., an electromagnetic emission, an electromagnetic absorbance, a fluorescence, a phosphorescence, a chemiluminescence, a refractive index, a cellular activity, a color shift, a fluorescence resonance energy transfer, a pH, a mass, a temperature, and the like. Detectable signals and detection systems are described further above. In some embodiments, the method further includes comparing the detected concentration of the unbound first component or the unbound second component with a control concentration of the unbound first component or the unbound second component to provide a measure of first and second components binding to one another. In certain embodiments, the determining step includes removing at least one aliquot of fluid from the first well, the second well, or both the first and second wells, and detecting the detectable signal in the aliquot. For example, the aliquot is removed from the first well, the second well, or both the first and second wells using a fluid handling component. Exemplary fluid handling components are described further above. Additional details relating to various types of binding assays that can be performed in the multi-well containers of the invention are described in, e.g., Keen (Ed.), Receptor Binding Techniques, Vol. 106, Humana Press (1998), Limbird, Cell Surface Receptors: A Short Course on Theory and Methods, Kluwer Academic Publishers (2000), Lieberman (Ed.), Steroid Receptor Methods: Protocols and Assays, Humana Press (2001), and Enna et al. (Eds.), Current Protocols in Pharmacology, John Wiley & Sons, Inc. (1998), each of which is incorporated by reference in its entirety.

Synthesis reactions are also optionally performed using the multi-well containers and systems of the invention. To illustrate, functionalized solid supports are optionally dispensed into one or both of two wells that communicate with one another via a chamber that includes a semi-permeable membrane disposed therein. Functionalized solid supports typically include linkers, scaffolds, building blocks, and/or other reactive moieties attached thereto. Examples of solid supports suitable for these methods include, e.g., glass supports, plastic supports, silicon supports, chips, beads, pins, or the like. Additional details regarding solid supports and other aspects of chemical synthesis are provided in, e.g., Sherrington (1998) “Preparation, structure, and morphology of polymer supports,” Chem. Commun. 2275-2286, Winter “Supports for solid-phase organic synthesis,” In Combinatorial Peptide and Non-Peptide Libraries (G. Jung, ed.), pp. 465-509. VCH, Weinheim (1996), and Hudson (1999) “Matrix-assisted synthetic transformations: a mosaic of different contributions. 1. The pattern emerges,” J. Comb. Chem. 1:330-360, which are each incorporated by reference in their entirety. Other reagents (e.g., reactants, catalysts, and/or the like) are optionally dispensed into one or both of the wells to effect the chemical synthesis.

Other methods that are optionally performed in the multi-well containers of the invention include cell and tissue culturing. Useful general references for culturing cells include, e.g., Freshney, Culture of Animal Cells, a Manual of Basic Technique, 3^{rd} Ed., Wiley-Liss (1994), Humason, Animal Tissue Techniques, 4^{th} Ed., W.H. Freeman and Company (1979), Ricciardelli et al., In Vitro Cell Dev. Biol. 25:1016-1024 (1989), Payne et al., Plant Cell and Tissue Culture in Liquid Systems, John Wiley & Sons, Inc. (1992), and Gamborg and Phillips (Eds.), Plant Cell, Tissue and Organ Culture; Fundamental Methods, Springer Lab Manual, Springer-Verlag (1995), which are each incorporated by reference in their entirety.

The following example is offered by way of illustration only and are not intended to limit the scope of the claimed invention.

VI. Example

This example illustrates equilibrium dialysis assays that were performed in a multi-well container of the invention to measure small molecule drug binding to plasma proteins. The assays included filling one well of a pair of wells that communicated via a chamber having a membrane disposed therein with human plasma and the other well of the pair with buffer. The assay included filling multiple pairs of wells in this manner. Each of the small molecules was dispensed into different wells containing plasma. The entire multi-well container was then heated at 37° C. with gentle shaking. The results of these assays are provided below in Table I, which includes the small molecule or compound name, the binding percentage detected for the compound in the multi-well container, and the binding percentage provided in the literature for the compound. Binding percentages were determined following detection using liquid chromatography/mass spectrometry.

TABLE I

| | Human plasma binding | |
|---|---|---|
| | percentage obtained in a | |
| | multi-well container of the | Plasma binding percentage |
| Compound | invention | stated in the literature |
| Imipramine | 95% | 95% |
| Nelfinavir | >99% | >98% |
| Propranolol | 91% | 93% |
| Theophylline | 47% | 56% |
| Tolbutamide | 98% | 96% |
| Trimethoprim | 65% | 44% |

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

1. A multi-well container, comprising:
at least two wells disposed in a surface of the multi-well container;
at least one chamber disposed in the multi-well container, which chamber communicates with the wells; and,
at least one membrane disposed in the chamber between the wells, wherein at least a portion of the membrane is disposed substantially normal to a bottom surface of the chamber.

2. The multi-well container of claim 1, wherein the multi-well container is disposable.

3. The multi-well container of claim 1, wherein the multi-well container is reusable.

4. The multi-well container of claim 1, wherein the membrane is semi-permeable.

5. The multi-well container of claim 1, wherein at least a portion of the wells, the chamber, or both the wells and the chamber comprise a non-adsorbing surface or a non-reactive surface.

6. The multi-well container of claim 1, wherein the chamber communicates with more than two wells.

7. The multi-well container of claim 1, wherein the chamber comprises at least one channel.

8. The multi-well container of claim 1, further comprising at least one sealing component that is structured to seal one or more of the wells disposed in the surface of the multi-well container.

9. The multi-well container of claim 1, wherein multiple lines of wells are disposed in the surface of the multi-well container and multiple chambers are disposed in the multi-well container, wherein one or more chambers communicate with at least one pair of wells disposed in identical lines of wells, different lines of wells, or both identical and different lines of wells.

10. The multi-well container of claim 9, wherein at least one of the chambers communicates with wells that are different from other wells with which other chambers communicate.

11. The multi-well container of claim 9, wherein each chamber communicates with a different pair of wells disposed in consecutive pairs of lines of wells.

12. The multi-well container of claim 9, wherein the multi-well container comprises n pairs of consecutive lines of wells and at least n membranes in which one or more membranes are disposed between each pair of consecutive lines of wells, and wherein n is an integer greater than 0.

13. The multi-well container of claim 9, wherein the multi-well container comprises 6, 12, 24, 48, 96, 192, 384, 768, 1536, or more wells.

14. The multi-well container of claim 1, wherein the wells are disposed in different segments of the multi-well container, which segments and membrane are separable from one another at least prior to assembly of the multi-well container.

15. The multi-well container of claim 14, wherein the segments comprise separable blocks.

16. The multi-well container of claim 14, wherein the multi-well container comprises n segments and at least n/2 membranes in which one or more membranes are disposed between at least one pair of adjacent segments, and wherein n is an integer greater than 1.

17. The multi-well container of claim 14, wherein the multi-well container comprises 2, 3, 4, 5, 6, 7, 8, 9, 10, 11, 12, 13, 14, 15, 16, 17, 18, 19, 20, or more separable segments.

18. The multi-well container of claim 14, wherein the segments are separable from one another along planes that are substantially vertically disposed through the multi-well container.

19. The multi-well container of claim 14, wherein the membrane is disposed between the segments when the multi-well container is assembled.

20. The multi-well container of claim 14, wherein each segment comprises a portion of the chamber.

21. The multi-well container of claim 14, further comprising at least one electrode disposed in electrical communication with each of the wells, a portion of the chamber, or each of the wells and a portion of the chamber.

22. The multi-well container of claim 14, wherein each segment comprises at least one line of wells and at least portions of multiple chambers.

23. The multi-well container of claim 22, wherein at least one of the portions of the chambers communicates with one or more wells disposed in the line of wells that are different from other wells disposed in the line of wells with which other portions of the chambers communicate.

24. The multi-well container of claim 23, wherein the portions of the chambers disposed in at least a first segment correspond to the portions of the chambers disposed in at least a second segment such that the corresponding portions of the chambers in the first and second segments communicate with one another when the multi-well container is assembled.

25. The multi-well container of claim 14, wherein the segments and the membrane are attached to one another using at least one attachment technique when the multi-well container is assembled.

26. The multi-well container of claim 25, wherein the attachment technique is selected from the group consisting of: bonding the segments together, adhering the segments together, bolting the segments together, screwing the segments together, and clamping the segments together.

27. The multi-well container of claim 1, further comprising at least one fluid handling component comprising at least one fluid handler that is structured to at least dispense one or more fluidic materials into one or more wells of the multi-well container.

28. The multi-well container of claim 27, wherein the fluid handling component comprises multiple fluid handlers, wherein at least two of the fluid handlers are spaced at a distance that substantially corresponds to a distance between two or more wells disposed in the multi-well container.

29. The multi-well container of claim 27, wherein the fluid handling component is hand-held.

30. The multi-well container of claim 27, wherein the fluid handling component comprises at least one translocation device that translocates the fluid handler and the multi-well container relative to one another.

31. The multi-well container of claim 27, further comprising at least one positioning component that is structured to position the multi-well container relative to the fluid handling component.

32. The multi-well container of claim 1, further comprising at least one thermal regulator operably connected to the multi-well container, which thermal regulator regulates temperature in the wells and chamber.

33. The multi-well container of claim 32, wherein the thermal regulator is integral with the multi-well container.

34. The multi-well container of claim 1, further comprising at least two electrodes disposed in electrical communication with at least one of the wells, a portion of the chamber, or at least one of the wells and a portion of the chamber.

35. The multi-well container of claim 34, further comprising at least one electrical power source operably connected to the electrodes to apply a voltage between the electrodes when conductive material is disposed in the wells and chamber of the multi-well container.

36. A multi-well container, comprising:
multiple lines of wells disposed in a surface of the multi-well container, wherein at least two of the lines of wells are disposed in different segments of the multi-well container, wherein the multi-well container comprises at least three segments, which segments are separable from one another at least prior to assembly of the multi-well container;
multiple chambers disposed in the multi-well container, wherein portions of at least one chamber are disposed in at least two of the segments, which chamber communicates with at least one well disposed in each of the two segments of the multi-well container; and,
at least one membrane disposed between the portions of the chamber such that the membrane is disposed in the chamber between the wells when the multi-well container is assembled.

37. A multi-well container, comprising:
multiple pairs of wells disposed in a surface of the multi-well container;
multiple chambers disposed in the multi-well container, wherein at least two of the chambers communicate with different pairs of wells; and,
multiple membranes disposed in the multi-well container, wherein at least two of the membranes are disposed in the chambers that communicate with the different pairs of wells.

38. A kit, comprising:
a multi-well container comprising:
at least two wells disposed in a surface of the multi-well container;
at least one chamber disposed in the multi-well container, which chamber communicates with the wells; and
at least one membrane disposed in the chamber between the wells, wherein at least a portion of the membrane is disposed substantially normal to a bottom surface of the chamber; and,
instructions for performing one or more assays or syntheses in the wells of the multi-well container.

39. The kit of claim 38, wherein the wells are disposed in different segments of the multi-well container, which segments and membrane are separable from one another.

40. The kit of claim 39, wherein the segments and the membrane are attached to one another using at least one attachment technique.

41. The kit of claim 39, wherein the kit further comprises instructions for assembling and dissembling the segments and the membrane.

42. A kit, comprising:
a multi-well container comprising:
multiple lines of wells disposed in a surface of the multi-well container, wherein at least two of the lines of wells are disposed in different segments of the multi-well container, wherein the multi-well container comprises at least three segments, which segments are separable from one another at least prior to assembly of the multi-well container;
multiple chambers disposed in the multi-well container, wherein portions of at least one chamber are disposed in at least two of the segments, which chamber communicates with at least one well disposed in each of the two segments of the multi-well container; and
at least one membrane disposed between the portions of the chamber such that the membrane is disposed in the chamber between the wells when the multi-well container is assembled; and,
instructions for performing one or more assays or syntheses in the wells of the multi-well container.

43. A method of performing a binding assay, the method comprising:
providing a multi-well container comprising at least two wells disposed in a surface of the multi-well container and at least one chamber disposed in the multi-well container, which chamber communicates with the wells, wherein at least one semi-permeable membrane is disposed in the chamber between the wells, and wherein at least a portion of the membrane is disposed substantially normal to a bottom surface of the chamber;
dispensing at least a first fluid into a first of the two wells, which first fluid comprises at least a first component;
dispensing at least a second fluid into the first or the second of the two wells, which second fluid comprises at least a second component; and,
determining whether the first component binds to the second component, thereby performing the binding assay.

44. The method of claim 43, wherein the semi-permeable membrane comprises a dialysis membrane.

45. The method of claim 43, wherein the first fluid comprises serum or plasma.

46. The method of claim 43, wherein the first and second components are independently selected from the group consisting of: organic molecules, inorganic molecules, ligands, drugs, polynucleotides, polypeptides, peptides, enzymes, receptors, antibodies, antigens, neurotransmitters, cytokines, chemokines, hormones, lipids, and carbohydrates.

47. The method of claim 43, wherein the first component is immobilized on a cellular membrane or on a surface of the first of the two wells.

48. The method of claim 43, wherein at least some unbound second component flows through the semi-permeable membrane from one well to another well.

49. The method of claim 43, wherein concentrations of unbound second component in the first and second wells are allowed to equilibrate prior to performing the determining step.

50. The method of claim 43, wherein the determining step comprises detecting at least one detectable signal that indicates a concentration of unbound first component or unbound second component.

51. The method of claim 43, wherein the detectable signal that indicates the concentration of the unbound first component or the unbound second component is detected multiple times when performing the binding assay.

52. The method of claim 43, wherein the detectable signal is detected in the first well, in the second well, or in both the first and second wells.

53. The method of claim 43, wherein the detectable signal is selected from the group consisting of: an electromagnetic emission, an electromagnetic absorbance, a fluorescence, a phosphorescence, a chemiluminescence, a refractive index, a cellular activity, a color shift, a fluorescence resonance energy transfer, a pH, a mass, and a temperature.

54. The method of claim 43, further comprising comparing the detected concentration of the unbound first component or the unbound second component with a control concentration of the unbound first component or the unbound second component to provide a measure of first and second components binding to one another.

55. The method of claim 43, further comprising dispensing at least one modulator into the first or second well before or after dispensing the second fluid into the first or second of the two wells, which modulator modulates binding of the first and second components to one another.

56. The method of claim 43, further comprising one or more of:
heating the fluids in the wells, centrifuging the fluids in the wells, or shaking the fluids in the wells.

57. The method of claim 43, further comprising sealing one or more of the wells disposed in the surface of the multi-well container.

58. The method of claim 43, wherein a cell population comprises the first component, which cell population is dispensed into the first of the two wells in the first fluid.

59. The method of claim 58, wherein the cell population is grown in the first of the two wells prior to dispensing the second fluid into the first or the second of the two wells.

60. The method of claim 43, wherein the determining step comprises removing at least one aliquot of fluid from the first well, the second well, or both the first and second wells, and detecting the detectable signal in the aliquot.

61. The method of claim 60, wherein the aliquot is removed from the first well, the second well, or both the first and second wells using at least one fluid handling component.

62. The method of claim 43, wherein the wells and at least portions of the chamber are disposed in different segments of the multi-well container, which segments and the semi-permeable membrane are separable from one another and wherein the providing step comprises placing the semi-permeable membrane over at least one of the portions of the chamber in at least one of the segments and attaching the segments to one another using at least one attachment technique such that the semi-permeable membrane is disposed in the chamber between the wells.

63. The method of claim 62, further comprising detaching the segments and the semi-permeable membrane from one another after the determining step and washing at least the segments.

64. The method of claim 43, further comprising dispensing at least a third fluid into the first or the second of the two wells.

65. The method of claim 64, wherein the third fluid comprises at least one buffer.

66. A method of fabricating a multi-well container, the method comprising:
providing a multi-well container fabrication element comprising at least two wells disposed through a surface of the multi-well container fabrication element and at least one chamber disposed in the multi-well container fabrication element, which chamber communicates with the wells;
separating the multi-well container fabrication element into at least two segments using at least one separation technique, wherein each segment comprises at least one well and at least a portion of the chamber;
disposing at least one membrane over the portion of the chamber disposed in at least one of the segments; and,
attaching the segments together using at least one attachment technique such that the membrane is disposed in the chamber between the wells, thereby fabricating the multi-well container.
